(19) United States
(12) Patent Application Publication
(10) Pub. No.: US 2008/0125018 A1
(43) Pub. Date: May 29, 2008

(54) SOLUTION FOR FIXED ABRASIVE CHEMICAL MECHANICAL POLISHING PROCESS AND FIXED ABRASIVE CHEMICAL MECHANICAL POLISHING METHOD

(75) Inventors: CHAN LU, TAINAN COUNTY (TW); TENG-CHUN TSAI, HSINCHU (TW); CHIH-YUEH LI, HSINCHU (TW); KAI-GIN YANG, TAINAN COUNTY (TW)

Correspondence Address: J C PATENTS, INC., 4 VENTURE, SUITE 250, IRVINE, CA, 92618, US

(73) Assignee: UNITED MICROELECTRONICS CORP., HSINCHU (TW)

(21) Appl. No.: 11/563,579

(22) Filed: Nov. 27, 2006

(51) Int. Cl. B24B 29/02; C09K 3/14

(52) U.S. Cl. 451/37; 51/308; 51/304

(57) ABSTRACT

A solution for fixed abrasive chemical mechanical polishing process including a protection constituent, a hydrolysis constituent and water is described. The protection constituent is used to protect a silicon nitride and its concentration is between 0.001 wt % and 10 wt %. The hydrolysis constituent is used to hydrolyze a silicon oxide and its concentration is between 0.001 wt % and 10 wt %. The concentration ofthe water is between 80 wt % and 99.998 wt %.

### BACKGROUND OF THE INVENTION

1. Field of the Invention

The present invention relates to a solution for fixed abrasive chemical mechanical polishing process and a fixed abrasive chemical mechanical polishing method. Particularly, the present invention relates to a solution for fixed abrasive chemical mechanical polishing process and a fixed abrasive chemical mechanical polishing method which can improve the polishing selectivity ratio and the remove rate.

2. Description of Related Art

In order to improve the integration of an electrical device as well as to lower the production cost in the process of fabricating a semiconductor device such as a memory wafer or a logic wafer, there is a trend to gradually improve an aspect ratio and to increase stack layers of conductive circuit layers in the recent fabricating process. Nevertheless, when fabricating multi-layer conductive circuit layer structure, the non-planar phenomenon such as convex-concave or distortion generated on a wafer surface will be increasingly eminent following by the increasing stack layers. Therefore, the technique to remove the non-planar phenomenon of the wafer surface and to achieve the global planarity has become a notable focus to all. Not only can utilize multi-layers conductive circuit layer structure on the device by using such global planarity technique, but also the yield rate of the fabricated device can be assured. IBM, an American Corporation, is the earliest to announce global planarity technique, which utilizes one of the global planarity techniques, the chemical mechanical polishing (CMP), to proceed damascene fabricating process among embedded conductive circuits. During the chemical mechanical polishing process, the abrasive particles and the polishing pad with proper elasticity and hardness are used, so as to achieve the planarization by a relative motion on the wafer surface.

However, when a slurry of the abrasive particles is used to process the chemical mechanical polishing of the shallow trench isolation (STI) in order to remove a silicon oxide on a silicon nitride of the active area, a dishing phenomenon is generated on the silicon oxide surface. The aforementioned dishing phenomenon is unable to be resolved as of today. Therefore, the more preferable adopted method recently is a kind of chemical mechanical polishing without slurry which is called fixed abrasive chemical mechanical polishing (FA-CMP) method. It is to fix the abrasive particles on the polish pad; namely, the polish pad is as an emery cloth (or, emery paper) that has the abrasive particles, thereby has the polishing function. The advantage of the aforementioned method is to provide with the polishing selective ratio of the silicon oxide to the silicon nitride and the planarization efficiency is better as well as the dishing phenomenon of the silicon oxide generated in the shallow trench is decreasing effectively.

In order to further shorten the product producing cycle, it is necessary to seek the fixed abrasive chemical mechanical method so as to improve the polishing selective ratio and remove rate effectively and to diminish the polishing time.

### SUMMARY OF THE INVENTION

Accordingly, a solution for fixed abrasive chemical mechanical polishing process is provided in the present invention to improve the polishing selective ratio of a silicon oxide to a silicon nitride.

The present invention further provides a fixed abrasive chemical mechanical method to improve the remove rate more effectively.

The present invention provides a solution for fixed abrasive chemical mechanical polishing process including a protection constituent, a hydrolysis constituent and water. The protection constituent is used to protect a silicon nitride and its concentration is between 0.001 wt % and 10 wt %. The hydrolysis constituent is used to hydrolyze a silicon oxide and its concentration is between 0.001 wt % and 10 wt %. The concentration of water is between 80 wt % and 99.998 wt %.

According to one embodiment of the present invention, in the aforementioned solution for fixed abrasive chemical mechanical polishing process, the protection constituent includes an ester.

According to one embodiment of the present invention, in the aforementioned solution for fixed abrasive chemical mechanical polishing process, the ester includes an L-proline.

According to one embodiment of the present invention, in the aforementioned solution for fixed abrasive chemical mechanical polishing process, the hydrolysis constituent includes a surfactant.

According to one embodiment of the present invention, in the aforementioned solution for fixed abrasive chemical mechanical polishing process, the surfactant includes a fluoroaliphatic polymeric ester.

According to one embodiment of the present invention, the solution for fixed abrasive chemical mechanical polishing process further includes an alkaline constituent.

According to one embodiment of the present invention, in the aforementioned solution for fixed abrasive chemical mechanical polishing process, the alkaline constituent adjusts the pH value of the solution between 9 and 12.

According to one embodiment of the present invention, in the aforementioned solution for fixed abrasive chemical mechanical polishing process, the alkaline constituent includes KOH, NaOH and NH₄OH.

A fixed abrasive chemical mechanical polishing method is provided in the present invention. Firstly, a wafer including a silicon oxide and a silicon nitride is provided. Next, the wafer is polished by using the polish pad where a plurality of abrasive particles are fixed on the polish pad. Then, the solution for fixed abrasive chemical mechanical polishing process is added on the wafer and the aforementioned solution includes a protection constituent, a hydrolysis constituent and water. The protection constituent is used to protect the silicon nitride and its concentration is between 0.001 wt % and 10 wt %. The hydrolysis constituent is used to hydrolyze the silicon oxide and its concentration is between 0.001 wt % and 10 wt %. The concentration of water is between 80 wt % and 99.998 wt %.

According to one embodiment of the present invention, in the aforementioned fixed abrasive chemical mechanical polishing method, the protection constituent includes an ester.

According to one embodiment of the present invention, in the aforementioned fixed abrasive chemical mechanical polishing method, the ester includes an L-proline.

According to one embodiment of the present invention, in the aforementioned fixed abrasive chemical mechanical polishing method, the hydrolysis constituent includes a surfactant.

According to one embodiment of the present invention, in the aforementioned fixed abrasive chemical mechanical polishing method, the surfactant includes the fluoroaliphatic polymeric ester.

According to one embodiment of the present invention, the aforementioned fixed abrasive chemical mechanical polishing method further includes an alkaline constituent.

According to one embodiment of the present invention, in the aforementioned fixed abrasive chemical mechanical polishing method, the alkaline constituent adjusts the pH value of the solution between 9 and 12.

According to one embodiment of the present invention, in the aforementioned fixed abrasive chemical mechanical polishing method, the alkaline constituent includes KOH, NaOH and NH₄OH.

Based on the above, the solution for fixed abrasive chemical mechanical polishing process described in the present invention is provided with the protection constituent that is used to protect the silicon nitride and the hydrolysis constituent that is used to hydrolyze the silicon oxide; thus, the polishing selective ratio of the silicon oxide to the silicon nitride can be improved more effectively. It should be noted that the polishing selective ratio of the silicon oxide to the silicon nitride improves, so as the process margin of the overly polishing process to be improved accordingly.

Furthermore, the solution added in the fixed abrasive chemical mechanical polishing method described in the present invention is provided with the protection constituent that is used to protect the silicon nitride and the hydrolysis constituent that is used to hydrolyze the silicon oxide; thus, the remove rate can be improved, the polishing time can be diminished and; further, the product producing cycle can be shortened.

In order to the make aforementioned and other objects, features and advantages of the present invention comprehensible, a preferred embodiment accompanied with figures are described in detail below.

### BRIEF DESCRIPTION OF THE DRAWINGS

FIG. 1 is a flow chart showing the fixed abrasive chemical mechanical method described in the present invention.

FIGS. 2A through 2C are schematic cross-sectional views showing the steps of forming a shallow trench isolation structure according to an embodiment of the present invention.

### DESCRIPTION OF EMBODIMENTS

First of all, the present invention provides a solution for fixed abrasive chemical mechanical polishing process including a protection constituent, a hydrolysis constituent and water. The solution used in the fixed abrasive chemical mechanical polishing process can improve the polishing selective ratio of a silicon oxide to a silicon nitride and the remove rate.

The protection constituent is used to protect the silicon nitride while proceeding the fixed abrasive chemical mechanical process. The concentration thereof is, for example, between 0.001 wt % and 10 wt % and the preferable concentration is between 0.005 wt % and 0.05 wt %. The protection constituent is, for example, an ester, such as L-proline.

The protection constituent is used to protect the silicon nitride while proceeding the fixed abrasive chemical mechanical process. The concentration thereof is, for example, between 0.001 wt % and 10 wt % and the preferable concentration is between 0.005 wt % and 0.05 wt %. The hydrolysis constituent is, for example, a surfactant, such as a fluoroaliphatic polymeric ester.

The concentration of water is, for example, between 80 wt % and 99.998 wt %. The water is, for example, used for solvent.

Moreover, it can further include an alkaline constituent in the solution to adjust the acid and alkaline value. The alkaline constituent is, for example, KOH, NaOH and NH4OH. The alkaline constituent is to adjust the pH value of the solution, for example, between 9 and 12, and preferably between 10 and 11.

Based on the above, the solution for fixed abrasive chemical mechanical polishing process described in the present invention is provided with the protection constituent that is used to protect the silicon nitride and the hydrolysis constituent that is used to hydrolyze the silicon oxide; thus, the polishing selective ratio of the silicon oxide to the silicon nitride can be improved more effectively while proceeding the fixed abrasive chemical mechanical polishing process. Moreover, the polishing selective ratio of the silicon oxide to the silicon nitride is improved; consequently, the process margin of the overly polishing process is improved accordingly.

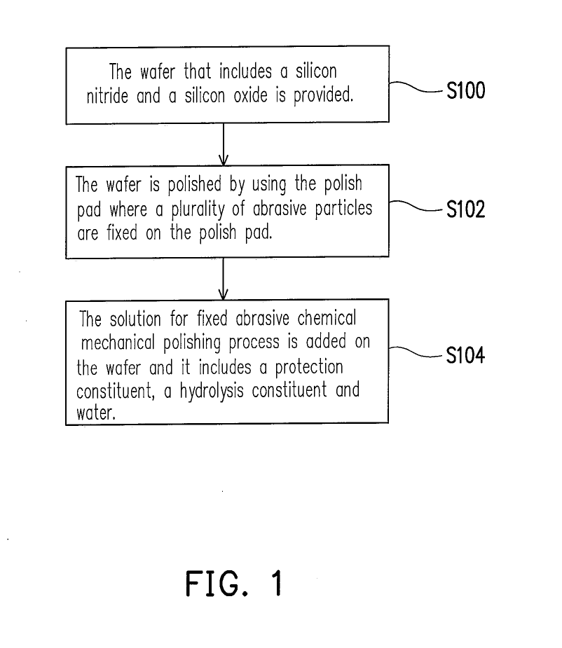

FIG. 1 is a flow chart showing the fixed abrasive chemical mechanical method described in the present invention.

Referring to FIG. 1, step S100 is performed, in which the wafer that includes a silicon nitride and a silicon oxide is provided firstly.

Step S102 is to be performed next, in which the wafer is polished by using the polish pad where a plurality of abrasive particles are fixed on the polish pad. Wherein, the wafer is polished by using the polish pad, such as the wafer surface is firstly contacting with the polish pad surface, then the wafer and polish pad are polishing by a relative motion mutually.

Next, referring to step S104, the solution for fixed abrasive chemical mechanical polishing process is added on the wafer and it includes a protection constituent, a hydrolysis constituent and water. Furthermore, the solution for fixed abrasive chemical mechanical polishing process further includes alkaline constituent. The concentration of each constituent and function used in the solution for fixed abrasive chemical mechanical polishing process are recited in detail above, so it is omitted for simplicity herein.

The fixed abrasive chemical mechanical polishing method provided in the present invention is applicable to polish the wafer with a silicon oxide and a silicon nitride. It is recited in the followings that the shallow trench isolation structure, for example, is fabricated by utilizing the fixed abrasive chemical mechanical polishing method.

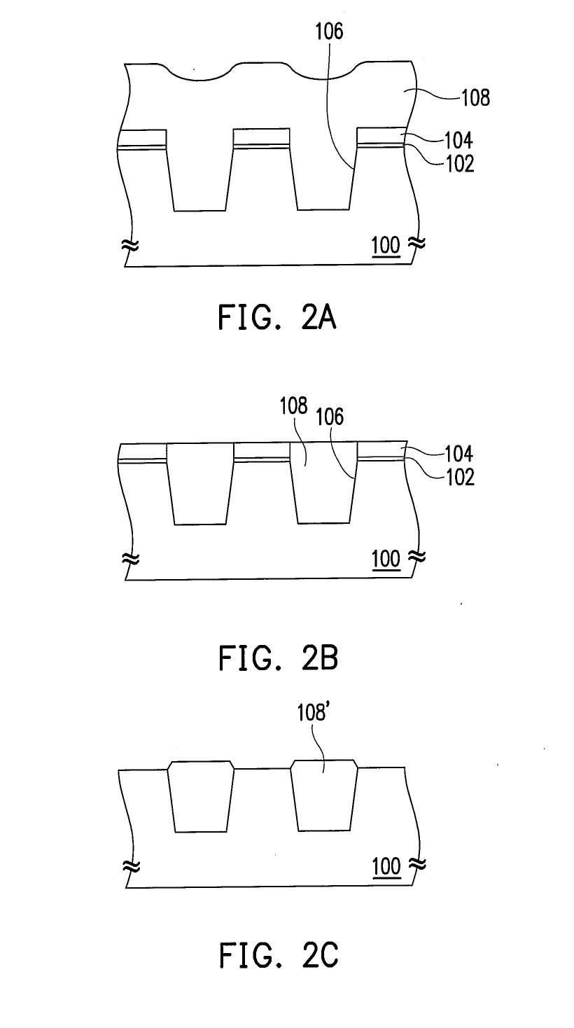

FIGS. 2A through 2C are schematic cross-sectional views showing the steps of forming a shallow trench isolation structure according to an embodiment of the present invention.

First of all, referring to FIG. 2A, a substrate 100 is provided where a patterned silicon nitride layer 104 is formed thereon and a trench 106 is formed therein. Meanwhile, the patterned the silicon nitride layer 104 exposes the trench 106. The substrate 100 is, for example, a silicon substrate. The forming method of a patterned silicon nitride layer 104 is, for example, to proceed a photolithography process and an etching process to a silicon nitride material layer after the silicon nitride material layer (not shown) on the substrate 100 is formed. The forming method of trench 106 is, for example, to use the patterned silicon nitride layer 104 as a mask and to proceed an etching process to the substrate 100.

Furthermore, it is alternate to form a pad oxide layer 102 on the substrate before forming the patterned silicon nitride layer 104 in order to prevent the patterned silicon nitride layer 104 generates strain stress on the substrate 100 and to enhance the adhesion force between the silicon nitride layer 104 and the substrate 100. The method of forming the pad oxide layer 102 includes performing a thermal oxidation process, for example.

Next, a silicon oxide layer 108 is formed on the patterned silicon nitride layer 104. Meanwhile, the trench 106 is filled with silicon oxide layer 108. The method of forming the silicon silicon oxide layer 108 includes, for example, chemical vapor deposition.

Next, referring to FIG. 2B, the silicon oxide layer 108 outside of the trench 106 is removed by the fixed abrasive chemical mechanical polishing method till the patterned silicon nitride layer 104 is exposed. The fixed abrasive chemical mechanical polishing method is, for example, using the polish pad having the fixed abrasive particles to polish the wafer and adding the solution for fixed abrasive chemical mechanical polishing process on the substrate 100. The concentration of each constituent and function used in the solution for fixed abrasive chemical mechanical polishing process are recited in detail above, so it is omitted for simplicity herein.

Next, referring to FIG. 2C, the patterned silicon nitride layer 104 and pad oxide layer 102 are removed sequentially in order to form a shallow trench isolation structure 108′ in the trench 106. The method of removing the patterned silicon nitride layer 104 and the pad oxide layer 102 is, for example, to use wet etching method to remove them sequentially.

In view of the foregoing, the solution added in the fixed abrasive chemical mechanical polishing method described in the present invention has the protection constituent that protects the silicon nitride and the hydrolysis constituent that hydrolyzes the silicon oxide in the polishing process; thus, the remove rate thereof can be improved, the polish time can be diminished and; further, the product producing cycle can be shortened.

In view of the above, the present invention has at least the following advantages.

1. The polish selective ratio of the silicon oxide to the silicon nitride can be improved by using the solution for fixed abrasive chemical mechanical polishing process described in the present invention.

2. As the polish selective ratio of the silicon oxide to the silicon nitride is improved by using solution for fixed abrasive chemical mechanical polishing process provided in the present invention, the process margin of the overly polishing process is improved accordingly.

3. As the fixed abrasive chemical mechanical polishing method in the present invention has high remove rate so as to diminish the polishing time as well as shorten the product producing cycle.

What is claimed is:

1. A solution for fixed abrasive chemical mechanical polishing process, comprising:
a protection constituent used to protect a silicon nitride, wherein the concentration of the protection constituent is between 0.001 wt % and 10 wt %;
a hydrolysis constituent used to hydrolyze a silicon oxide, wherein the concentration of the hydrolysis constituent is between 0.001 wt % and 10 wt %; and
water, wherein the concentration of the water is between 80 wt % and 99.998 wt %.

2. The solution for fixed abrasive chemical mechanical polishing process of claim 1, wherein the protection constituent includes an ester.

3. The solution for fixed abrasive chemical mechanical polishing process of claim 2, wherein the ester includes an L-proline.

4. The solution for fixed abrasive chemical mechanical polishing process of claim 1, wherein the hydrolysis constituent includes a surfactant.

5. The solution for fixed abrasive chemical mechanical polishing process of claim 4, wherein the surfactant includes fluoroaliphatic polymeric ester.

6. The solution for fixed abrasive chemical mechanical polishing process of claim 1, further comprising an alkaline constituent.

7. The solution for fixed abrasive chemical mechanical polishing process of claim 6, wherein the alkaline constituent adjusts the pH value of the solution between 9 and 12.

8. The solution for fixed abrasive chemical mechanical polishing process of claim 6, wherein the alkaline constituent includes KOH, NaOH or NH₄OH.

9. A fixed abrasive chemical mechanical polishing method, comprising:
providing a wafer which includes a silicon oxide and a silicon nitride;
polishing the wafer by using a polish pad where a plurality of abrasive particles are fixed on the polish pad; and
adding the solution for fixed abrasive chemical mechanical polishing process on the wafer, wherein the solution comprises:
a protection constituent that used to protect the silicon nitride, wherein the concentration of the protection constituent is between 0.001 wt % and 10 wt %;
a hydrolysis constituent that used to hydrolyze the silicon oxide, wherein the concentration of the hydrolysis constituent is between 0.001 wt % and 10 wt %; and
water, wherein the concentration of the water is between 80 wt % and 99.998 wt %.

10. The fixed abrasive chemical mechanical polishing method of claim 9, wherein the protection constituent includes an ester.

11. The fixed abrasive chemical mechanical polishing method of claim 10, wherein the ester includes an L-proline.

12. The fixed abrasive chemical mechanical polishing method of claim 9, wherein the hydrolysis constituent includes a surfactant.

13. The fixed abrasive chemical mechanical polishing method of claim 12, wherein the surfactant includes fluoroaliphatic polymeric ester.

14. The fixed abrasive chemical mechanical polishing method of claim 9, further comprising an alkaline constituent.

15. The fixed abrasive chemical mechanical polishing method of claim 14, wherein the alkaline constituent adjusts the pH value of the solution between 9 and 12.

16. The fixed abrasive chemical mechanical polishing method of claim 14, wherein the alkaline constituent includes KOH, NaOH or NH4OH.
